(19) United States
(12) Patent Application Publication
(10) Pub. No.: US 2009/0091239 A1
(43) Pub. Date: Apr. 9, 2009

(54) LIGHT-EMITTING CHIP AND METHOD OF MANUFACTURING THE SAME

(75) Inventors: Don-Chan CHO, Seongnam-si (KR); Jae-Byung PARK, Seongnam-si (KR); Hae-Il PARK, Seoul (KR); Jin-Seob BYUN, Seoul (KR); Sung-Jin HONG, Seoul (KR); Seul LEE, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/113,390

(22) Filed: May 1, 2008

(30) Foreign Application Priority Data
Oct. 4, 2007 (KR) 10-2007-0099577

(51) Int. Cl. H01J 1/62; H01J 9/00

(52) U.S. Cl. 313/503; 445/23; 977/950

(57) ABSTRACT

A light-emitting chip includes a light-emitting part, a first color-converting part and a second color-converting part. The light-emitting part includes a first electrode and a second electrode, and generates first light of a first wavelength. The first color-converting part is formed on a light-emitting surface of the light-emitting part. The first color-converting part converts at least a portion of the first light into second light of a second wavelength. The second color-converting part is formed on the first color-converting part. The second color-converting part converts at least a portion of the first light into third light of a third wavelength that is shorter than the second wavelength. Thus, a fluorescent substance of a long wavelength and a fluorescent substance of a short wavelength are sequentially formed on a light-emitting surface of a light-emitting part, so that the color reproducibility of a light-emitting chip may be enhanced.

This application claims priority to Korean Patent Application No. 2007-99577, filed on Oct. 4, 2007, and all the benefits accruing therefrom under 35 U.S.C. §119, and the contents of which in its entirety are herein incorporated by reference.

### BACKGROUND OF THE INVENTION

1. Field of the Invention

The present invention relates to a light-emitting chip and a method of manufacturing the light-emitting chip. More particularly, the present invention relates to a light-emitting chip that emits white light and a method of manufacturing the light-emitting chip.

2. Description of the Related Art

In general, a light-emitting diode (“LED”) has merits, such as environmentally friendly characteristics, high color reproducibility, low power consumption, etc., so that the LED has been employed in liquid crystal display (“LCD”) devices, lighting devices, etc.

Three color LEDs that generate red light, green light and blue light, respectively, are used in order to achieve high color reproducibility. Alternatively, a multi-chip structure including three color LEDs that are packaged into one package may be used in order to achieve high color reproducibility. However, if three color LEDs are used, manufacturing costs may increase. Furthermore, in order to form white light, three color LEDs are required to be independently controlled due to differences in reliability among the three color LEDs, and thus the applicability of manufactured products may be decreased.

In order to solve the above weak points, various structures have been developed. For one example, a first combination structure including a blue chip generating blue light and a fluorescent substance emitting yellow light has been developed. For another example, a second combination structure including a blue chip generating blue light and fluorescent substances emitting red and green light has been developed. For still another example, a third combination structure including an ultraviolet chip generating ultraviolet light and fluorescent substances emitting red, green and blue light has been developed. That is, at least two fluorescent substances are used to form white light.

### BRIEF SUMMARY OF THE INVENTION

It has been determined herein, according to the present invention, that when at least two fluorescent substances are mixed non-sequentially and deposited on a light-emitting chip, a color-converting fluorescent substance of a long wavelength reabsorbs light of a color-converting fluorescent substance of a short wavelength, so that white light may not be generated.

The present invention provides a light-emitting chip capable of enhancing color reproducibility.

The present invention also provides a method of manufacturing the above-mentioned light-emitting chip.

The present invention also provides a method of manufacturing a light-emitting diode (“LED”) including the above-mentioned light-emitting chip.

In exemplary embodiments of the present invention, a light-emitting chip includes a light-emitting part, a first color-converting part and a second color-converting part. The light-emitting part includes a first electrode and a second electrode. The light-emitting part generates first light of a first wavelength in response to a voltage. The first color-converting part is formed on a light-emitting surface of the light-emitting part. The first color-converting part converts at least a portion of the first light into second light of a second wavelength. The second color-converting part is formed on the first color-converting part. The second color-converting part converts at least a portion of the first light into third light of a third wavelength that is shorter than the second wavelength.

In an exemplary embodiment, the light-emitting part may generate the first light of a blue wavelength. Here, the first color-converting part may include a fluorescent substance that converts the first light into the second light of a red wavelength, and the second color-converting part may include a fluorescent substance that converts the first light into the third light of a green wavelength.

In an exemplary embodiment, the light-emitting part may generate the first light of an ultraviolet wavelength. Here, the light-emitting chip may further include a third color-converting part formed on the second color-converting part. The third color-converting part may convert at least a portion of the first light into fourth light of a fourth wavelength that is shorter than the third wavelength. Here, the first color-converting part may include a fluorescent substance that converts the first light into the second light of a red wavelength, the second color-converting part may include a fluorescent substance that converts the first light into the third light of a green wavelength, and the third color-converting part may include a fluorescent substance that converts the first light into the fourth light of a blue wavelength. For example, the light-emitting part may generate light of a wavelength of about 380 nm to about 400 nm.

In an exemplary embodiment, the first and second color-converting parts may each include nanocrystal materials having particle sizes, the particle sizes of the nanocrystal materials in the first color-converting part different from the particle sizes of the nanocrystal materials in the second color-converting part. The nanocrystal materials may include at least one of zinc sulfide (ZnS), cadmium sulfide (CdS), cadmium selenide (CdSe) and indium phosphide (InP).

In other exemplary embodiments of the present invention, in order to manufacture a light-emitting chip, a light-emitting part is formed, such as on a wafer, to include a first electrode and a second electrode. The light-emitting part generates first light of a first wavelength in response to a voltage. Then, a first color-converting part is formed on a light-emitting surface of the light-emitting part. The first color-converting part converts at least a portion of the first light into second light of a second wavelength. Then, a second color-converting part is formed on the first color-converting part. The second color-converting part converts at least a portion of the first light into third light of a third wavelength that is shorter than the second wavelength.

In an exemplary embodiment, the first and second color-converting parts may be formed through a printing process using a mask. Alternatively, the first and second color-converting parts may be formed through an inkjet process using a mask.

In an exemplary embodiment, when the light-emitting part includes a blue chip generating the first light having a blue wavelength, the first color-converting part may include a fluorescent substance converting the first light into the second light having a red wavelength, and the second color filter converting part may include a fluorescent substance converting the first light into the third light having a green wavelength.

Alternatively, when the light-emitting part includes an ultraviolet light chip generating light of an ultraviolet wavelength, a third color-converting part may be formed on the second color-converting part, which converts at least a portion of the first light into fourth light having a fourth wavelength that is shorter than the third wavelength. Here, the first color-converting part may include a fluorescent substance converting the first light into the second light having a red wavelength, the second color-converting part may include a fluorescent substance converting the first light into the third light having a green wavelength, and the third color-converting part may include a fluorescent substance converting the first light into the fourth light having a blue wavelength.

In still other exemplary embodiments of the present invention, in order to manufacture an LED, a light-emitting part is formed on a wafer, which includes a first electrode and a second electrode. The light-emitting part generates first light of a first wavelength in response to a voltage. Then, a first color-converting part is formed on a light-emitting surface of the light-emitting part. The first color-converting part converts at least a portion of the first light into second light of a second wavelength. Then, a second color-converting part is formed on the first color-converting part. The second color-converting part converts at least a portion of the first light into third light of a third wavelength that is shorter than the second wavelength. Then, the light-emitting part having the first and second color-converting parts formed therein is die-bonded to a lead frame. Then, the first and second electrodes are wire-bonded to the lead frame.

According to the light-emitting chip and the method of manufacturing the light-emitting chip of the present invention, a fluorescent substance of a long wavelength and a fluorescent substance of a short wavelength are sequentially formed on a light-emitting surface of a light-emitting part, so that the color reproducibility of a light-emitting chip may be enhanced.

### BRIEF DESCRIPTION OF THE DRAWINGS

The above and other features and advantages of the present invention will become readily apparent by reference to the following detailed description when considered in conjunction with the accompanying drawings wherein:

FIG. 1 is a perspective view illustrating an exemplary light-emitting diode (“LED”) according to an exemplary embodiment of the present invention;

FIG. 2 is a cross-sectional view taken along line I-I′ of FIG. 1;

FIG. 3 is a plan view illustrating the exemplary LED of FIG. 1;

FIGS. 4 to 7 are drawings illustrating an exemplary manufacturing process of the exemplary LED shown in FIGS. 1 to 3; and

FIG. 8 is a cross-sectional view illustrating an exemplary LED according to another exemplary embodiment of the present invention.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

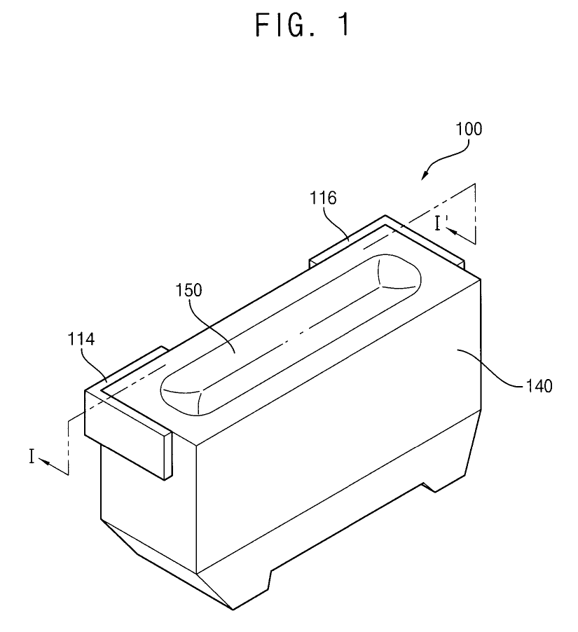

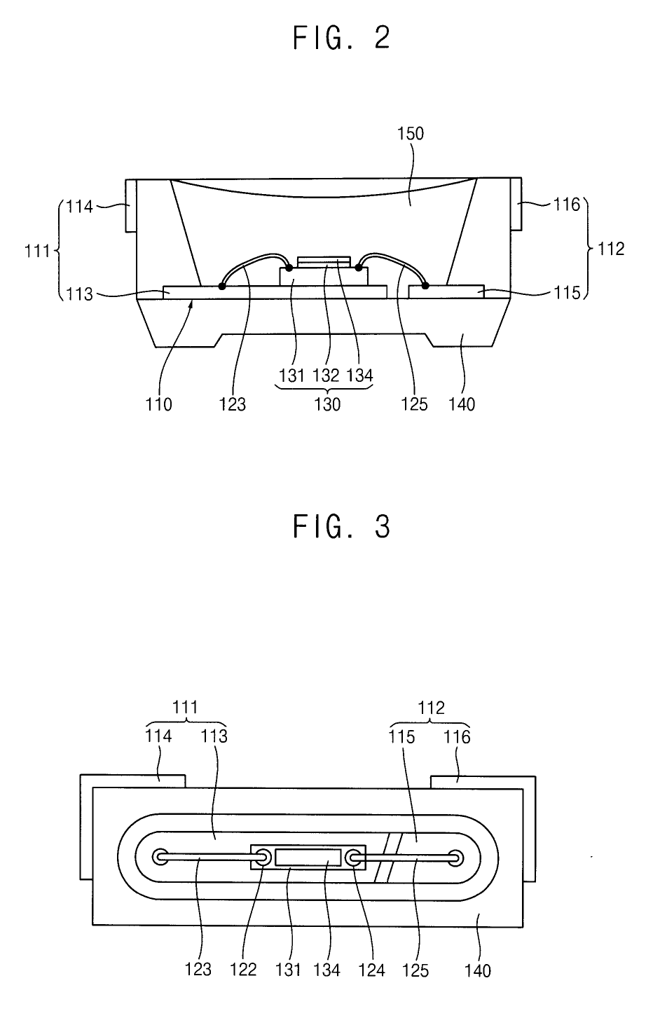

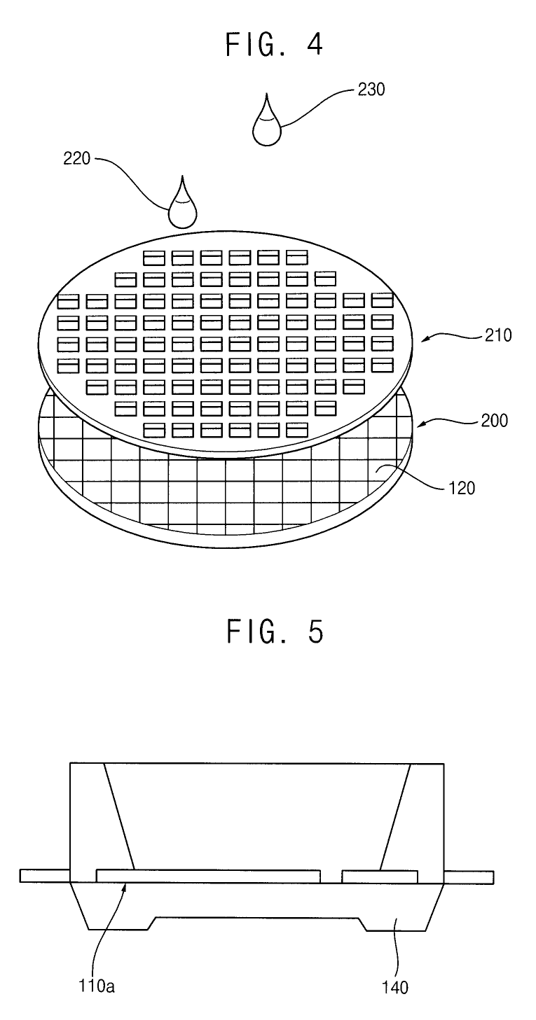

FIG. 1 is a perspective view illustrating an exemplary light-emitting diode (“LED”) according to an exemplary embodiment of the present invention. FIG. 2 is a cross-sectional view taken along line I-I′ of FIG. 1. FIG. 3 is a plan view illustrating the exemplary LED of FIG. 1.

Referring to FIGS. 1, 2 and 3, an LED 100 according to an exemplary embodiment of the present invention includes a lead frame 110, a light-emitting chip 130 and a case 140.

The lead frame 100 may include a metal material for providing the light-emitting chip 130 with external power. For example, the lead frame 110 may include a steel material, although other conductive materials are within the scope of these embodiments.

The lead frame 110 includes a first frame 111 for applying a first voltage to the light-emitting chip 130, and a second frame 112 for applying a second voltage different from the first voltage to the light-emitting chip 130. The first frame 111 and the second frame 112 are spaced apart from each other to be electrically isolated from each other.

The first frame 111 may include a first internal frame 113 disposed in the interior of the case 140, and a first external frame 114 extended from the first internal frame 113 to be disposed on the exterior of the case 140. The first internal frame 113 is a portion that is electrically connected to the light-emitting chip 130, and the first external frame 114 is a portion that is electrically connected to an external power supply (not shown).

Moreover, the second frame 112 may include a second internal frame 115 disposed in the interior of the case 140, and a second external frame 116 extended from the second internal frame 115 to be disposed on the exterior of the case 140. The second internal frame 115 is a portion that is electrically connected to the light-emitting chip 130, and the second external frame 116 is a portion that is electrically connected to an external power supply (not shown).

The case 140 may include an insulation material so as to protect the light-emitting chip 130 and the lead frame 110 and insulate the light-emitting chip 130 from the lead frame 110. For example, the case 140 may include a polymer or a ceramic material. A recess is formed in the case 140, which exposes the lead frame 110 mounted therein and the light-emitting chip 130. The recess may have a narrower width at the light-emitting chip 130 than at an outer portion of the case 140, such as a funnel shape, so that light generated from the light-emitting chip 130 may be dispersed at a wide angle. A reflective layer (not shown) for reflecting light may be formed on an internal surface of the case 140, such as on an internal surface of the recess.

The light-emitting chip 130 is fixed to the lead frame 110 to be disposed in the interior of the case 140. For example, the light-emitting chip 130 may be fixed to the first internal frame 113 of the lead frame 110. Alternatively, the light-emitting chip 130 may be fixed to the first and second internal frames 113 and 115. Alternatively, the light-emitting chip 130 may be fixed to the second internal frame 115.

The light-emitting chip 130 includes a light-emitting part 131, a first color-converting part 132 and a second color-converting part 134. The first color-converting part 132 is a layer formed on the light-emitting part 131, and the second color-converting part 134 is a layer formed on the first color-converting part 132, such that the first color-converting part 132 is disposed between the light emitting part 131 and the second color-converting part 134.

The light-emitting part 131 may include a first electrode 122 and a second electrode 124 for receiving external power. The first and second electrodes 122 and 124 may be formed on an upper portion of the light-emitting part 131, where the upper portion of the light-emitting part 131 faces the recess and the direction of light emission. The upper portion of the light-emitting part 131 may be a light-emitting surface. An opposing lower portion of the light-emitting part 131 may be disposed on the lead frame 110. The first electrode 122 is electrically connected to the first internal frame 113 through a first lead wire 123, and the second electrode 124 is electrically connected to the second internal frame 115 through a second lead wire 125.

Therefore, the first voltage applied from an external power supply is applied to the first electrode 122 of the light-emitting part 131 through the first external frame 114, the first internal frame 113 and the first lead wire 123. Moreover, the second voltage applied from the external power supply is applied to the second electrode 124 of the light-emitting part 131 through the second external frame 116, the second internal frame 115 and the second lead wire 125.

The light-emitting part 131 generates first light of a first wavelength in response to the first and second voltages applied to the first and second electrodes 122 and 124, respectively. In this exemplary embodiment, the light-emitting part 131 may include a blue chip that generates light of a blue wavelength, about 450 to about 495 nm.

The first and second color-converting parts 132 and 134 are formed on a light-emitting surface of the light-emitting part 131 so as to convert light of a blue wavelength generated from the light-emitting part 131 into light having a wavelength different from the blue wavelength. For example, the first and second color-converting parts 132 and 134 may be formed on a space of the upper portion of the light-emitting part 131 between the first electrode 122 and the second electrode 124.

The first color-converting part 132 is formed on the light-emitting surface of the light-emitting part 131, and converts at least a portion of the first light generated from the light-emitting part 131 into second light of a second wavelength. For example, the first color-converting part 132 may include a first fluorescent substance that converts the first light into light of a red wavelength, such as about 620 nm to about 750 nm, that is a relatively long wavelength, with respect to the wavelength of the first light generated from the light-emitting part 131.

The second color-converting part 134 is formed on the first color-converting part 132, and converts at least a portion of the first light generated from the light-emitting part 131 into third light of a third wavelength that is shorter than the second wavelength. For example, the second color-converting part 134 may include a second fluorescent substance that converts the first light into light of a green wavelength, such as about 495 nm to about 570 nm, that is a relatively short wavelength, with respect to the wavelength of the second light. The wavelength of the third light may be longer than the wavelength of the first light.

Therefore, first light of a blue wavelength, second light of a red wavelength and third light of a green wavelength are mixed to form white light. The first light is generated from the light-emitting part 131. The second light is generated from the first color-converting part 132. The third light is generated from the second color-converting part 134.

Accordingly, when the first color-converting part 132 including a first fluorescent substance generating a red wavelength and the second color-converting part 134 including a second fluorescent substance generating a green wavelength are sequentially formed on the light-emitting part 131, the first fluorescent substance of a long wavelength may prevent the light of the second fluorescent substance of a short wavelength from being absorbed so that the color reproducibility of white light may be enhanced.

The first and second color-converting parts 132 and 134 may include nanocrystal materials having particle sizes different from each other so as to generate light of different wavelengths. The wavelength of the light differs according to the particle sizes of the nanocrystal materials included in the first and second color-converting parts 132 and 134. Thus, the particle sizes of the nanocrystal materials included in each of the first and second color-converting parts 132 and 134 are adjusted, so that light of a red wavelength and light of a green wavelength may be generated, respectively. For example, the nanocrystal materials may include at least one of zinc sulfide (ZnS), cadmium sulfide (CdS), cadmium selenide (CdSe), indium phosphide (InP), etc. Alternatively, the first and second color-converting parts 132 and 134 may include organic fluorescent substances different from each other or inorganic fluorescent substances different from each other so as to generate light of a red wavelength and light of a green wavelength, respectively.

The LED 100 may further include a mold member 150 that fills the interior portion of the case 140 having the light-emitting chip 130 mounted therein. That is, the mold member 150 may fill the funnel-shaped recess in the case 140. The mold member 150 may fill the interior of the case 140 to protect the light-emitting chip 130. The mold member 150 may include silicon, an epoxy resin, etc.

In this exemplary embodiment, the light-emitting chip 130 is an LED 100 mounted in the interior of the case 140. Alternatively, the light-emitting chip 130 according to the present invention may generate white light through the first and second color-converting parts 132 and 134, so that the light-emitting chip 130 may be employed in a backlight device of a display device or another illumination device. Moreover, a wafer having the light-emitting chip 130 manufactured thereon may be employed in a backlight device of a display device or another illumination device.

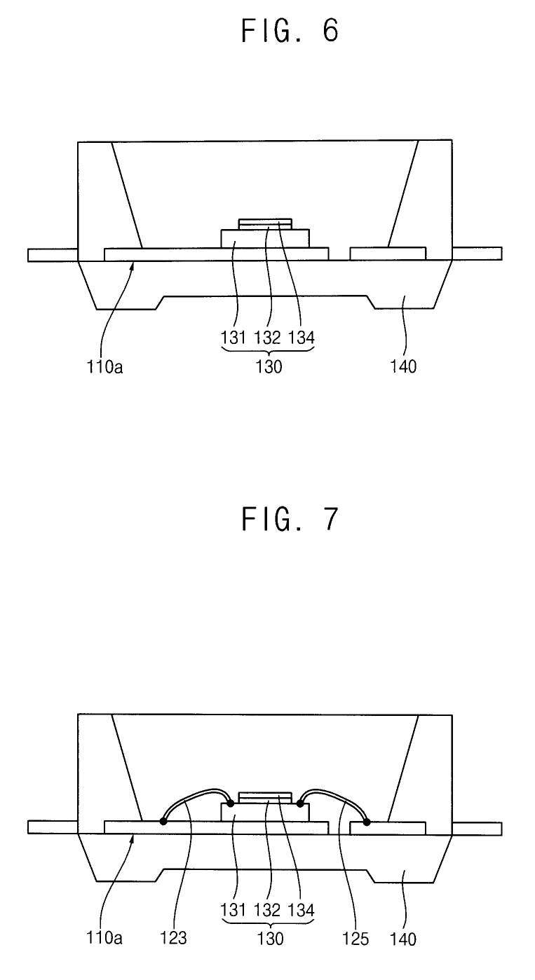

Hereinafter, an exemplary method of manufacturing the exemplary LED shown in FIGS. 1 to 3 will be described in detail with reference to the following FIGS. 4 to 7.

FIGS. 4 to 7 are drawings illustrating an exemplary manufacturing process of the exemplary LED shown in FIGS. 1 to 3. Particularly, FIG. 4 shows an exemplary manufacturing process of the exemplary light-emitting chip shown in FIGS. 2 and 3.

Referring to FIGS. 2, 3 and 4, a light-emitting part 131 is formed on a wafer 200 so as to manufacture the light-emitting chip 130. For example, the wafer 200 may include a sapphire substrate. The light-emitting part 131 including first and second electrodes 122 and 124 is formed on the wafer 200 through four to five mask processes. The light-emitting part 131 generates first light of a first wavelength in response to a voltage source applied through the first and second electrodes 122 and 124. For example, the light-emitting part 131 may include a blue chip that generates light of a blue wavelength.

Then, a first color-converting part 132 and a second color-converting part 134 are sequentially formed on a light-emitting surface of the light-emitting part 131. The first and second color-converting parts 132 and 134 are formed on the light-emitting part 131, except in areas where the first and second electrodes 122 and 124 are formed. The first and second color-converting parts 132 and 134 may be formed on an upper surface of the light-emitting part 131 between the first and second electrodes 122 and 124. The first and second color-converting parts 132 and 134 may be partially formed on the light-emitting part 131 through a mask 210. For example, the first and second color-converting parts 132 and 134 may be formed through a printing process using the mask 210. Alternatively, the first and second color-converting parts 132 and 134 may be formed through an inkjet process using the mask 210.

For example, the mask 210 may be disposed on the wafer 200 having the light-emitting part 131 formed thereon, and then a first color-converting material 220 including a fluorescent substance generating light of a red wavelength may be deposited on the light-emitting part 131 through a printing process or inkjet process to form the first color-converting part 132. Then, a second color-converting material 230 including a fluorescent substance generating light of a green wavelength is deposited on the first color-converting part 132 through a printing process or an inkjet process to form a second color-converting part 134.

Then, the light-emitting chip 130 is separated from the wafer 200 after the light-emitting chip 130 including the light-emitting part 131 and the first and second color-converting parts 132 and 134 are formed on the light-emitting part 131. Here, a chemical lift-off method, a laser lift-off (“LLO”) method, etc., may be used in order to separate the light-emitting part 131 from the wafer 200.

Referring to FIG. 5, in addition to forming the light-emitting chip 130, a case 140 having a preprocessed lead frame 110a mounted thereon is manufactured. For example, the preprocessed lead frame 110a may be punched on a flat metal plate, and then a resin for manufacturing the case 140 may fill the case 140 to manufacture the case 140 having the preprocessed lead frame 110a mounted thereon. Alternatively, a liquid resin may be injected into a mold in which the preprocessed lead frame 110a is installed, and then the case 140 having the preprocessed lead frame 110a mounted thereon may be manufactured through an insert molding process that solidifies the liquid resin.

Referring to FIG. 6, the light-emitting chip 130 including the light-emitting part 131, and the first and second color-converting parts 132 and 134 is die-bonded to the preprocessed lead frame 110a that is mounted in the case 140 to fix the light-emitting chip 130. For example, the light-emitting chip 130 may be fixed to the preprocessed lead frame 110a through an adhesive material such as, for example, a silver paste and so on.

Referring to FIGS. 3 and 7, a wire-bonding process is performed so as to electrically connect the light-emitting chip 130 to the preprocessed lead frame 110a. Thus, an electrode 122 of the light-emitting chip 130 is electrically connected to a first internal frame 113 through a first lead wire 123, and a second electrode 124 is electrically connected to a second internal frame 115 through a second lead wire 125.

Referring to FIG. 2, a mold member 150 including a transparent material such as silicon fills the interior of the case 140 having the light-emitting chip 130 mounted thereon.

Then, in order to electrically connect to an external power supply (not shown), the preprocessed lead frame 110a is processed to form a lead frame 110 including the first and second external frames 114 and 116.

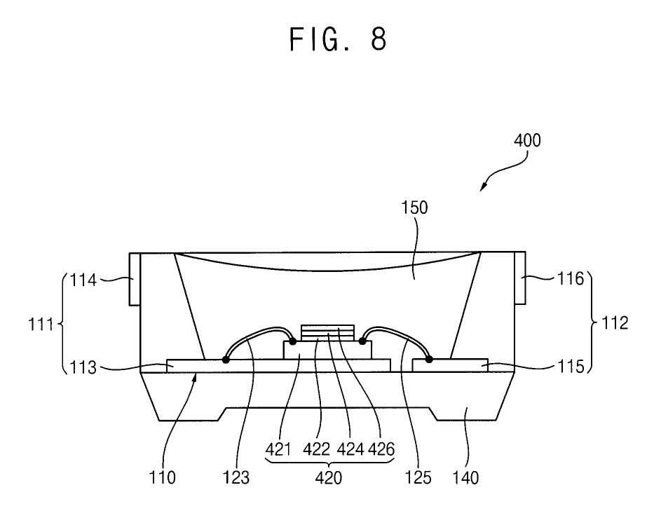

FIG. 8 is a cross-sectional view illustrating an exemplary LED 400 according to another exemplary embodiment of the present invention. In FIG. 8, the LED is substantially the same as the LED of FIGS. 1 to 3, except for a light-emitting chip. Thus, the same reference numerals will be used to refer to the same or like parts as those described in FIGS. 1 to 3 and any further explanation concerning the above elements will be omitted.

Referring to FIG. 8, an LED 400 according to another exemplary embodiment of the present invention includes a light-emitting chip 420 including a light-emitting part 421, a first color-converting part 422, a second color-converting part 424 and a third color-converting part 426. The first color-converting part 422 is a layer formed on the light-emitting part 421, the second color-converting part 424 is a layer formed on the first color-converting part 424, and the third color-converting part 426 is a layer formed on the second color-converting part 424, such that the first color-converting part 422 is disposed between the light emitting part 421 and the second color-converting part 424, and the second color-converting part 424 is disposed between the first color-converting part 422 and the third color-converting part 426.

In the exemplary embodiment, the light-emitting part 421 generates first light of a first wavelength. The light-emitting part 421 may include an ultraviolet chip generating light of an ultraviolet wavelength. For example, the light-emitting part 421 may generate light of a near-ultraviolet wavelength of about 380 nm to about 400 nm.

The first, second and third color-converting parts 422, 424 and 426 are formed on a light-emitting surface of the light-emitting part 421 so as to convert light of an ultraviolet wavelength generated from the light-emitting part 421 into white light. Here, the first color-converting part 422 is formed on the light-emitting surface of the light-emitting part 421, and the second color-converting part 424 is formed on the first color-converting part 422. The third color-converting part 426 is formed on the second color-converting part 424, such that the second color-converting part 424 is disposed between the first color-converting part 422 and the third color-converting part 426.

The first color-converting part 422 converts at least a portion of the first light generated from the light-emitting part 421 into second light of a second wavelength. For example, the first color-converting part 422 may include a first fluorescent substance that converts light of an ultraviolet wavelength generated from the light-emitting part 421 into light of a red wavelength that is a long wavelength, as compared to ultraviolet wavelength.

The second color-converting part 424 converts at least a portion of the first light that is generated from the light-emitting part 421 into third light of a third wavelength that is shorter than the second wavelength. For example, the second color-converting part 424 may include a second fluorescent substance that converts light of an ultraviolet wavelength generated from the light-emitting part 421 into light of a green wavelength that is shorter than that of the second light.

The third color-converting part 426 converts at least a portion of the first light that is generated from the light-emitting part 421 into fourth light of a fourth wavelength that is shorter than the third wavelength. For example, the third color-converting part 426 may include a third fluorescent substance that converts light of an ultraviolet wavelength generated from the light-emitting part 421 into light of a blue wavelength that is shorter than that of the third light.

Therefore, second light of a red wavelength, third light of a green wavelength and fourth light of a blue wavelength are mixed to form white light. The second light is generated from the first color-converting part 422, and the third light is generated from the second color-converting part 424. The fourth light is generated from the third color-converting part 426.

As described above, when the first color-converting part 422 including a first fluorescent substance generating a red wavelength, the second color-converting part 424 including a second fluorescent substance generating a green wavelength and the third color-converting part 426 including a third fluorescent substance generating a blue wavelength are sequentially formed on the light-emitting part 421, a fluorescent substance of a long wavelength may prevent the light of a fluorescent substance of a short wavelength from being absorbed so that the color reproducibility of white light may be enhanced. In other words, the color-converting parts 422, 424, 426 are arranged in order on the light-emitting part 421 to convert first light from the light-emitting part 421 to second, third, and fourth lights, respectively, that have decreasing wavelengths.

The first, second and third color-converting parts 422, 424 and 426 may include nanocrystal materials having particle sizes different from each other so as to generate light of different wavelengths. For example, the nanocrystal materials may include at least one of zinc sulfide (ZnS), cadmium sulfide (CdS), cadmium selenide (CdSe) and indium phosphide (InP). Alternatively, the first, second and third color-converting parts 422, 424 and 426 may include organic fluorescent substances different from each other or inorganic fluorescent substances different from each other so as to generate light of a red wavelength, light of a green wavelength, and light of a blue wavelength, respectively.

The first, second and third color-converting parts 422, 424 and 426 may be partially formed on the light-emitting part 421 using the mask 210 through substantially the same manufacturing process as that described with respect to FIG. 4. For example, the first, second and third color-converting parts 422, 424 and 426 may be formed through a printing process or an inkjet process using the mask 210.

Hereinafter, a forming process of the first, second and third color-converting parts 422, 424 and 426 will be described. The mask 210 is disposed on the wafer 200 having the light-emitting part 421 formed thereon, and then a first color-converting material including a fluorescent substance generating light of a red wavelength is deposited on the light-emitting part 421 through a printing process or inkjet process to form a first color-converting part 422. Then, a second color-converting material including a second fluorescent substance generating light of a green wavelength is deposited on the first color-converting part 422 through a printing process or an inkjet process to form a second color-converting part 424. Then, a third color-converting material including a third fluorescent substance generating light of a blue wavelength is deposited on the second color-converting part 424 through a printing process or an inkjet process to form a third color-converting part 426.

According to the light-emitting chip and the method of manufacturing the light-emitting chip of the present invention, a fluorescent substance of a long wavelength and a fluorescent substance of a short wavelength are sequentially formed on a light-emitting surface of a light-emitting part, and the fluorescent substance of the long wavelength may prevent the light of the fluorescent substance of the short wavelength from being absorbed so that the color reproducibility of a light-emitting chip may be enhanced.

Although exemplary embodiments of the present invention have been described, it is understood that the present invention should not be limited to these exemplary embodiments but various changes and modifications can be made by one of ordinary skill in the art within the spirit and scope of the present invention as hereinafter claimed.

What is claimed is:

1. A light-emitting chip comprising:
a light-emitting part including a first electrode and a second electrode, the light-emitting part generating first light of a first wavelength in response to a voltage;
a first color-converting part formed on a light-emitting surface of the light-emitting part, the first color-converting part converting at least a portion of the first light into second light of a second wavelength; and
a second color-converting part formed on the first color-converting part, the second color-converting part converting at least a portion of the first light into third light of a third wavelength that is shorter than the second wavelength.

2. The light-emitting chip of claim 1, wherein the light-emitting part generates the first light of a blue wavelength.

3. The light-emitting chip of claim 2, wherein the first color-converting part includes a fluorescent substance that converts the first light into the second light of a red wavelength, and the second color-converting part includes a fluorescent substance that converts the first light into the third light of a green wavelength.

4. The light-emitting chip of claim 1, wherein the light-emitting part generates the first light of an ultraviolet wavelength.

5. The light-emitting chip of claim 4, further comprising:
a third color-converting part formed on the second color-converting part, the third color-converting part converting at least a portion of the first light into fourth light of a fourth wavelength that is shorter than the third wavelength.

6. The light-emitting chip of claim 5, wherein the first color-converting part includes a fluorescent substance that converts the first light into the second light of a red wavelength, the second color-converting part includes a fluorescent substance that converts the first light into the third light of a green wavelength, and the third color-converting part includes a fluorescent substance that converts the first light into the fourth light of a blue wavelength.

7. The light-emitting chip of claim 6, wherein the light-emitting part generates the first light of a wavelength of about 380 nm to about 400 nm.

8. The light-emitting chip of claim 1, wherein the first and second color-converting parts each include nanocrystal materials having particle sizes, and the particle sizes of the nanocrystal materials in the first color-converting part are different from the particle sizes of the nanocrystal materials in the second color-converting part.

9. The light-emitting chip of claim 8, wherein the nanocrystal materials include at least one of zinc sulfide (ZnS), cadmium sulfide (CdS), cadmium selenide (CdSe) and indium phosphide (InP).

10. A method of manufacturing a light-emitting chip, the method comprising:
forming a light-emitting part including a first electrode and a second electrode, the light-emitting part generating first light of a first wavelength in response to a voltage;
forming a first color-converting part on a light-emitting surface of the light-emitting part, the first color-converting part converting at least a portion of the first light into second light of a second wavelength; and
forming a second color-converting part on the first color-converting part, the second color-converting part converting at least a portion of the first light into third light of a third wavelength that is shorter than the second wavelength.

11. The method of claim 10, wherein the first and second color-converting parts are formed through a printing process using a mask.

12. The method of claim 10, wherein the first and second color-converting parts are formed through an inkjet process using a mask.

13. The method of claim 10, wherein the light-emitting part includes a blue chip generating the first light having a blue wavelength.

14. The method of claim 13, wherein the first color-converting part includes a fluorescent substance converting the first light into the second light having a red wavelength, and the second color filter converting part includes a fluorescent substance converting the first light into the third light having a green wavelength.

15. The method of claim 10, wherein the light-emitting part includes an ultraviolet light chip generating the first light of an ultraviolet wavelength.

16. The method of claim 15, further comprising:
forming a third color-converting part on the second color-converting part, which converts at least a portion of the first light into fourth light having a fourth wavelength that is shorter than the third wavelength.

17. The method of claim 16, wherein:
the first color-converting part includes a fluorescent substance converting the first light into the second light having a red wavelength;
the second color-converting part includes a fluorescent substance converting the first light into the third light having a green wavelength; and
the third color-converting part includes a fluorescent substance converting the first light into the fourth light having a blue wavelength.

18. The method of claim 10, wherein the first and second color-converting parts each include nanocrystal materials having particle sizes, and the particle sizes of the nanocrystal materials in the first color-converting part are different from the particle sizes of the nanocrystal materials in the second color-converting part.

19. The method of claim 18, wherein the nanocrystal materials include at least one of zinc sulfide (ZnS), cadmium sulfide (CdS), cadmium selenide (CdSe) and indium phosphide (InP).

20. The method of claim 10, wherein forming the light-emitting part includes forming the light-emitting part on a wafer.

21. A method of manufacturing a light-emitting diode, the method comprising:
forming a light-emitting part including a first electrode and a second electrode on a wafer, the light-emitting part generating first light of a first wavelength in response to a voltage;
forming a first color-converting part on a light-emitting surface of the light-emitting part, the first color-converting part converting at least a portion of the first light into second light of a second wavelength;
forming a second color-converting part on the first color-converting part, the second color-converting part converting at least a portion of the first light into third light of a third wavelength that is shorter than the second wavelength;
die-bonding the light-emitting part having the first and second color-converting parts formed thereon to a lead frame; and
wire-bonding the first and second electrodes to the lead frame.
